(19) United States
(12) Patent Application Publication
(10) Pub. No.: US 2004/0111252 A1
(43) Pub. Date: Jun. 10, 2004

(54) Method and system for emulating a design under test associated with a test environment

(75) Inventors: Luc Burgun, Sucy en Brie (FR); David Reynier, Orsay (FR); Sebastien Delerse, Chilly-Mazarin (FR); Frederic Emirian, Chilly-Mazarin (FR); Francois Douezy, Poissy (FR)

Correspondence Address: FITZPATRICK CELLA HARPER & SCINTO, 30 ROCKEFELLER PLAZA, NEW YORK, NY, 10112, US

(73) Assignee: EMULATION AND VERIFICATION ENGINEERING, Palaiseau (FR)

(21) Appl. No.: 10/603,776

(22) Filed: Jun. 26, 2003

(30) Foreign Application Priority Data
Jun. 26, 2002 (FR) 0207949

(51) Int. Cl. G06F 9/455

(52) U.S. Cl. 703/28

(57) ABSTRACT

The method of emulating the design under test associated with a test environment comprises two distinct generating phases comprising a first phase of generating (80) a first file (FCH1) for configuring the test environment, and a second phase of generating (81) a second file (FCH2) for configuring at least a part of the design under test, the delivery of the first configuration file to a first reconfigurable hardware part (BTR) forming a reconfigurable test bench so as to configure the test bench, and the delivery of the second configuration file to a second reconfigurable hardware part (EML) so as to configure an emulator of the design under test, the two hardware parts being distinct and mutually connected.

The invention relates to the field of electronic computer aided design (electronic CAD) and more especially to that of the functional verification of integrated circuits and more generally of electronic systems.

The invention applies in particular to the implementation of a test environment for a circuit whose operation one seeks to validate (and referred to as the “design under test”) and which is emulated entirely or partly by a reconfigurable hardware system.

These reconfigurable hardware systems generally encompass emulation systems (or “emulators”) and prototyping systems at one and the same time. Hereinafter, the word “emulator” will be used to designate a “reconfigurable hardware system”, and hence prototyping systems will be included under this term.

Reconfigurable hardware systems consist of one or several cards on which there are reconfigurable circuits of FPGA (Field Programmable Gate Array) type or custom reconfigurable circuits, and which are connected together according to fixed or reconfigurable means. The cards constituting the reconfigurable hardware system can be plugged into one or more racks. An interface caters for the communication of the reconfigurable hardware system with a control computer (or host computer). Historically, the first reconfigurable hardware systems of this type were reduced to their simplest expression, that is to say a single reconfigurable circuit mounted on a card and which offered a single mode of validation, namely in-circuit emulation.

In this case, the test environment for the circuit consists of the target system which is in due course to receive the design under test, of cables and of connectors allowing the target system to communicate with the reconfigurable circuit placed on another printed circuit. Reconfigurable circuits generally being slower than the custom circuits which one seeks to embody and to validate, it might be necessary to slow down the speed of the target system in order for the reconfigurable circuit to operate correctly.

Reconfigurable hardware systems have subsequently evolved in order to offer both more capacity and more functionality. At the functionalities level, several test environment alternatives have thus been proposed:

test environment based on test vectors embedded in the reconfigurable system: the test vectors can be stored in one or more memories of the reconfigurable system and a logic comparator is implemented for comparing the outputs of the design under test with the expected outputs,

test environment consisting of a synthesisable hardware model embedded in the reconfigurable system: the test environment can be described by a hardware model which can be emulated and hence implemented directly into the reconfigurable system,

test environment consisting of a hardware model simulated on the host computer: the test environment can be described by a hardware model which will be simulated (it cannot be synthesised) on the host computer. A link between the host computer and the reconfigurable system affords communication between the simulated test environment and the emulated design under test.

Each test environment exhibits different characteristics as regards performance, ease of implementation and flexibility of use. From the performance point of view, a general rule requires the gain to be a maximum in relation to simulation by software when the test environment is embodied directly by hardware. This hardware may be the target system (in-circuit emulation mode) or an installation of the test environment by the reconfigurable hardware system (stimulation based on test vectors or hardware model of embedded stimulation). Nevertheless, this approach is not always conceivable, in particular because the description of a hardware model of a test environment may prove to be very difficult to embody and to maintain. Circuit designers often prefer to model their test environment at a level of abstraction which is both higher than and different from that used to describe their design under test.

A current trend consists in wishing to stimulate the design under test by software, seeking a gain in performance similar to that obtained by a reconfigurable system in a mode where it is stimulated only by hardware. This approach is especially beneficial when the target system has not yet been finalized, when the test environment is supposed to change considerably during the validation of the design under test or finally when seeking to debug the design under test at a higher level of abstraction.

Recently, a consortium (called the “Standard Co-Emulation API Consortium) has been created, the objective of which is to define a standardized interface for reconfigurable hardware systems making it possible to validate a design under test using a program written in the C language or in the C++ language. This interface provides several communication channels which allow software models of the test environment to communicate with the emulated design under test.

This interface has been more especially defined to support a type of communication between a software model and the design under test referred to as transactional. A transaction may be defined as a specific sequence of transition on a collection of signals during a given period.

In this mode of stimulation and observation, several hardware blocks are added to the periphery of the design under test so as to translate the transactional data originating from the software model into bit/signal type data compatible with the real interface of the design under test and vice versa. These hardware blocks, also referred to as transactors, are embodied by the reconfigurable hardware system.

This mode results in a considerable increase in the logic used in the reconfigurable hardware system to embody all or part of the test environment. These requirements for additional software resources are also accompanied by greater requirements for performance. The hardware blocks catering for the translation of data at the transactional level to the bit/signal level may thus become the bottleneck as regards performance since they may incorporate complex translation mechanisms requiring several clock cycles.

It is therefore necessary to take the characteristics of these new test environments into account when defining future reconfigurable hardware system architectures, this including the emulation systems and also the prototyping systems.

Currently, the part of the test environment which is embedded in the reconfigurable hardware system and the design under test are both implemented by the same configurable resources. This consequently results in a very strong dependence between the test environment and the design under test. Therefore, a modification in the test environment (for example a transactor) may entail recompilation of the design under test although the latter has not changed. Conversely, a modification in the design under test may involve recompilation of the test environment although the latter has not changed.

In addition, currently, the hardware used is generic hardware which is not necessarily suitable for the implementation of a test environment, whether this be in terms of speed or density. Specifically, the structure of a test environment is very specific. Some of these blocks have to operate at considerable frequencies which are difficult to obtain and to guarantee with a generic reconfigurable hardware system. The emulation of the hardware part of the test environment by a generic emulator may ultimately have a negative impact on the overall performance of the emulation system.

The generic nature of reconfigurable hardware systems therefore results in under-use of the hardware resources, lack of performance and longer compilation times.

Moreover, current reconfigurable hardware systems are very limited as regards their capacity to mix several modes of stimulation. It is thus impossible to implement heterogeneous test environments including various types of modelling, various levels of communication, or even various means of simulation.

In addition, the trend in reconfigurable circuits is evolving towards ever more compact integration so that a single reconfigurable circuit may be sufficient to emulate a circuit of considerable size (of the order of a million gates) in the very near future. A reconfigurable circuit such as this will indeed be able to cover the requirements of the designers of intellectual property blocks, of specific circuits (ASIC) and by definition of circuits implemented on reconfigurable circuits (FPGA). By defining a reconfigurable hardware system based on a single reconfigurable circuit, one circumvents the very complex problems inherent in compilation for systems with several reconfigurable circuits, such as partitioning, management of the buses and clocks. The system may then rely directly on the compilation chain of the reconfigurable circuit supplier, thereby limiting the development burden and offering a standard solution which is easy to deploy and to support.

The invention is intended to afford a solution to these problems.

An aim of the invention is to define a novel architecture of simulation/emulation platform taking account of the evolving trend in the complexity of test environments, of performance requirements and of the evolving trend in the technology of reconfigurable circuits.

An aim of the invention is to allow the description of very complex mixed (hardware and software) test environments while offering performance and integration in keeping with market demand.

The simulation/emulation platform according to the invention is thus based on an approach in which the reconfigurable system emulating the design under test is separated from that emulating the hardware part of its test environment. This approach is applied especially well to the case where the reconfigurable hardware system emulating the design under test is based on a single reconfigurable circuit, but it may easily be extended to cases of more complex reconfigurable hardware systems.

The invention therefore proposes a method of emulating a design under test associated with a test environment, this process comprising:

two distinct generating phases comprising a first phase of generating a first file for configuring the test environment, and a second phase of generating a second file for configuring at least a part of the design under test,

the delivery of the first configuration file to a first reconfigurable hardware part forming a reconfigurable test bench so as to configure the test bench, and

the delivery of the second configuration file to a second reconfigurable hardware part so as to configure an emulator of the design under test, the two hardware parts being distinct and mutually connected.

Thus, each hardware part may for example be embodied by means of a reconfigurable circuit of the FPGA type.

The first generating phase and the second generating phase may be performed in parallel or sequentially and, in the latter case, the order scarcely matters. Specifically, the first generating phase can be performed before or after the second generating phase.

According to one mode of implementation of the invention, the first generating phase comprises the production of a logic circuit consisting of a network of logic gates representative of the test environment as well as of the compilation directives. The first generating phase also comprises a compilation of this logic circuit having regard to the said directives, so as to obtain the first configuration file.

According to one mode of implementation, the test environment comprises a collection of drivers and of monitors. The production of the said logic circuit then comprises the formation of hardware blocks in the form of networks of logic gates, these hardware blocks representing interfaces of drivers/monitors of software stimulation, interfaces of drivers/monitors of hardware stimulation, and drivers/monitors of emulated hardware stimulation. The production of the logic circuit also comprises the formation of an interface block allowing the above-cited hardware blocks to communicate with the emulator of the design under test.

When the first generating phase (generation of the test bench configuration file) is performed after the second generating phase (configuration of the emulator), the production of the logic circuit uses as input parameters a description of the assignment of the logic inputs/outputs of the design under test to the pins of the emulator.

On the other hand, when the second generating phase is performed after the first generating phase, the production of the logic circuit uses as input parameters a description of the interface of the design under test and supplies as output a description of the assignment of the logic inputs/outputs of the design under test to the pins of the emulator, this output description then being a constraint parameter for the second generating phase.

In other words, producing the configuration of the reconfigurable test bench before the emulator imposes more constraints on the compiler of the design under test, but is simpler for the user.

On the other hand, beginning with the generation of the configuration of the emulator of the design under test offers more density since the compilation of the design under test is not constrained by an a priori assignment of its inputs/outputs to the pins of the emulator which embodies it.

Onwards of the moment at which a first generation has been effected in respect of the configuration of the design under test and that of the reconfigurable test bench, it is advantageous to reuse the thus-determined assignment of the inputs/outputs for the succeeding generations, thereby avoiding the recompilation of the test environment when only the design under test has changed and vice versa.

An object of the invention is also an emulation system, intended to emulate a design under test associated with a test environment.

According to a general characteristic of the invention, the system comprises a reconfigurable hardware test bench capable of emulating a part at least of the test environment, this test bench being connected between a host computer and a reconfigurable hardware emulator, distinct from the test bench, and capable of emulating at least a part of the design under test.

The system furthermore comprises first generating means able to generate a first file for configuring the test environment, and second generating means able to generate a second file for configuring at least a part of the design under test.

According to one embodiment of the invention, the reconfigurable test bench comprises a so-called fixed part and at least one reconfigurable circuit capable of embodying the emulated part of the test environment.

Within the meaning of the invention, a fixed part is understood to be a part which does not vary as a function of the test environment as opposed to a reconfigurable part which is configured case by case as a function of the test environment. Thus, the fixed part could be embodied by immutable circuits (nonreconfigurable), or possibly by circuits which are reconfigurable but have fixed circuitry.

According to one embodiment of the invention, the fixed part comprises at least one control circuit and one circuit for interfacing with the host computer. The reconfigurable circuit embodying the emulated part of the test environment is moreover able to comprise at least interfaces of drivers/monitors of software stimulation which are capable of establishing a communication with at least one software process executed on the host computer, as well as drivers/monitors of emulated hardware stimulation.

The fixed part can furthermore comprise additional real hardware drivers/monitors. The reconfigurable circuit embodying the emulated part of the test environment is then able furthermore to comprise interfaces with these additional real hardware drivers/monitors. The fixed part can also furthermore comprise a circuit for interfacing with a target device so as to be able to carry out an in-circuit emulation.

The fixed part can also come in the form of a single circuit which then incorporates the control circuit, the circuit for interfacing with the host computer and the circuit for interfacing with the target device.

It should also be noted that the circuit for interfacing with the target device can also be embodied in the reconfigurable circuit or circuits embodying the emulated part of the test environment, thereby making it possible to limit the number of circuits to be traversed to make the design under test communicate with its target device.

The test bench and the emulator may be embodied on an electronic card external to the host computer and connected to the latter's mother card across an interface card.

As a variant, the test bench may be embodied on a first electronic card external to the host computer and connected to the latter's mother card across an interface card whereas the emulator can be embodied on one or more other cards external to the host computer and connected to the said first external card.

As a variant, the test bench and the emulator can be embodied on an internal electronic card incorporated into the host computer.

In this case, the circuit for interfacing with a possible target device may be embodied on an external electronic card outside the host computer, and able to be connected to the said internal electronic card.

An object of the invention is also an electronic card, intended to be connected to the mother card of a host computer, comprising a reconfigurable hardware test bench capable of emulating a part at least of a test environment associated with a design under test, and a reconfigurable hardware emulator, distinct from the test bench, connected to the reconfigurable test bench and capable of emulating at least a part of the design under test.

The reconfigurable test bench can comprise a so-called fixed part and at least one reconfigurable circuit capable of embodying the emulated part of the test environment.

Other advantages and characteristics of the invention will become apparent on examining the detailed description of a mode of implementation and embodiment, which is in no way limiting, and of the appended drawings in which:

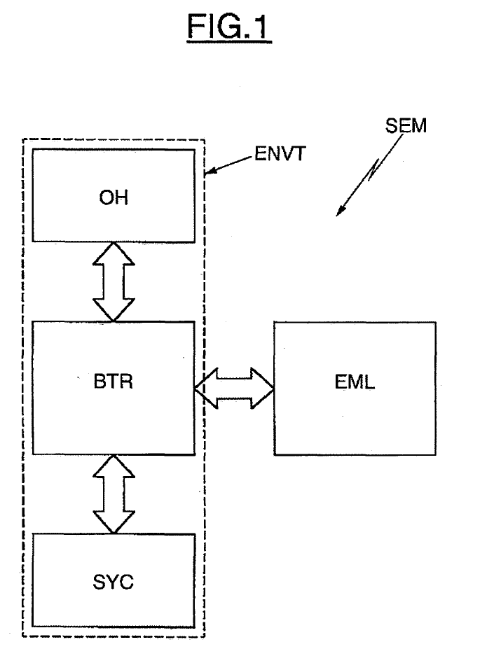

FIG. 1 diagrammatically illustrates an embodiment of an emulation system according to the invention,

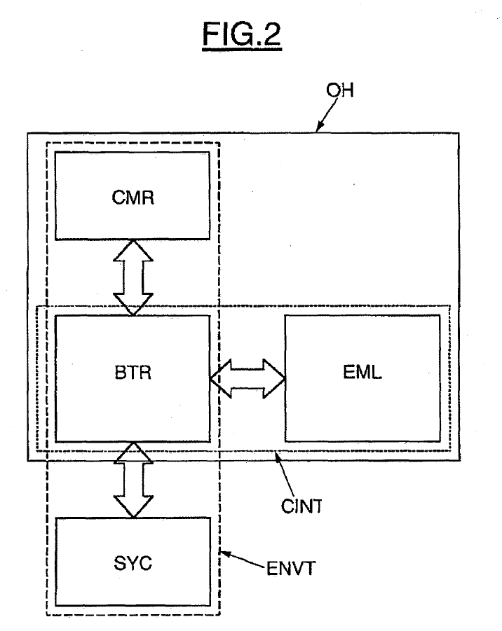

FIG. 2 illustrates an embodiment of the emulation system according to the invention when the reconfigurable test bench and the emulator are integrated into the host computer,

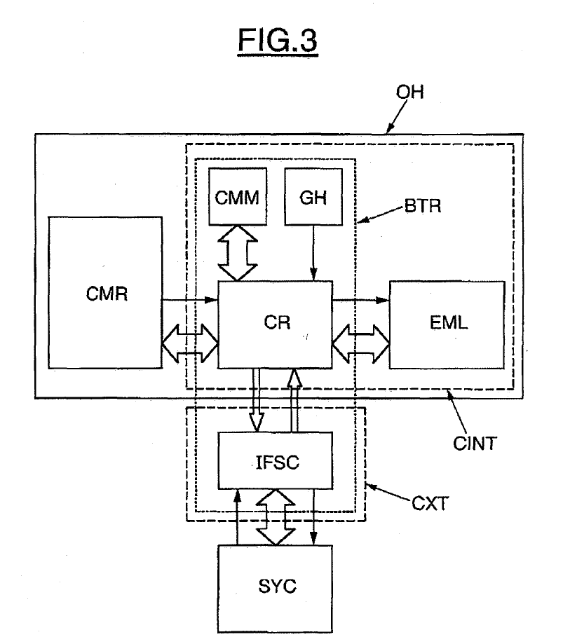

FIG. 3 illustrates in greater detail, but still diagrammatically, a general architecture of a reconfigurable test bench according to the invention,

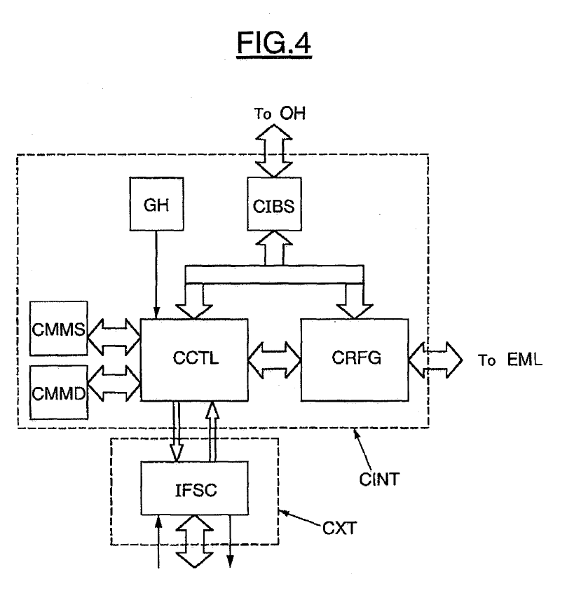

FIG. 4 illustrates in greater detail a part of FIG. 3,

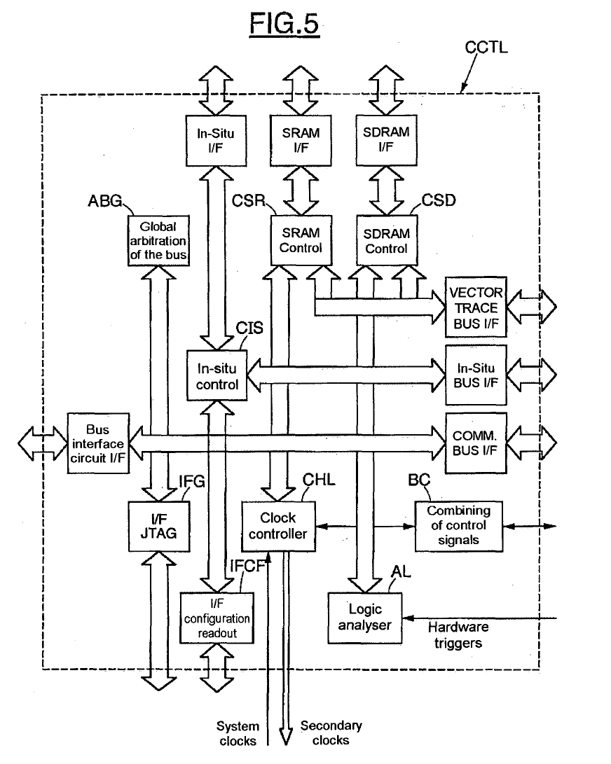

FIG. 5 diagrammatically illustrates an embodiment of a control circuit of a reconfigurable test bench,

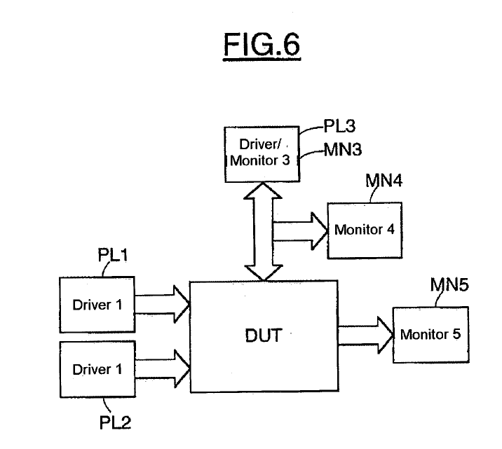

FIG. 6 diagrammatically illustrates an exemplary test environment for a design under test,

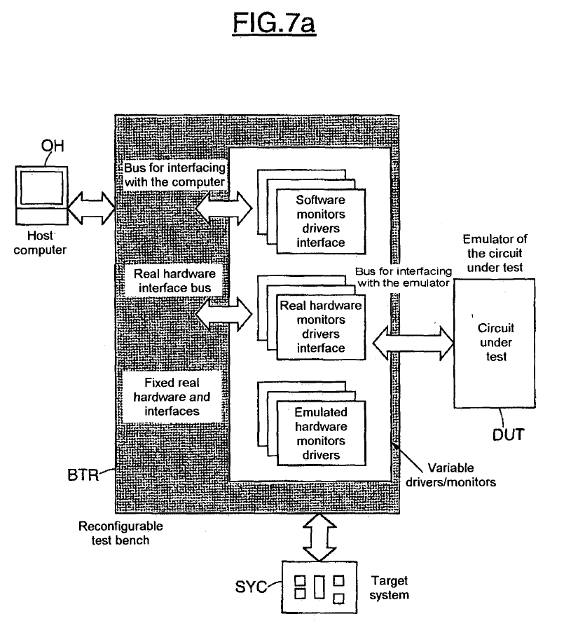

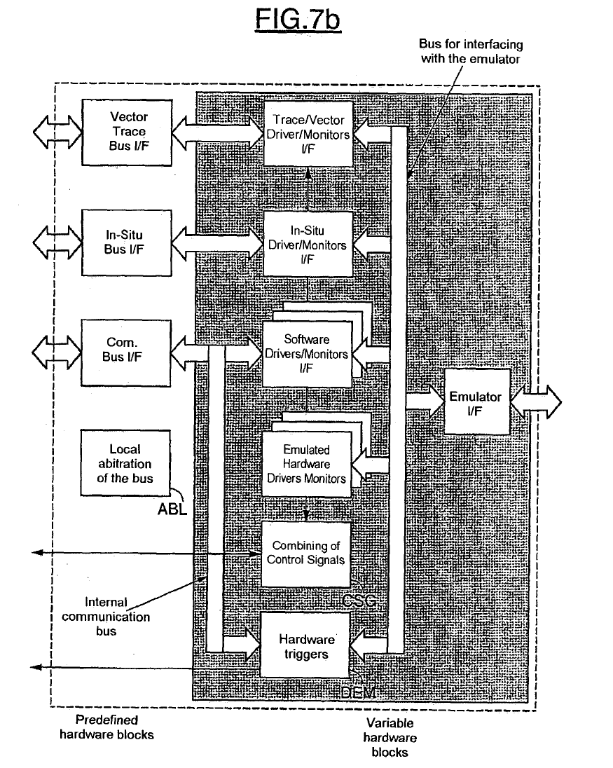

FIG. 7a diagrammatically illustrates another representation of a reconfigurable test bench according to the invention,

FIG. 7b diagrammatically illustrates an embodiment of a reconfigurable interface circuit of a reconfigurable test bench,

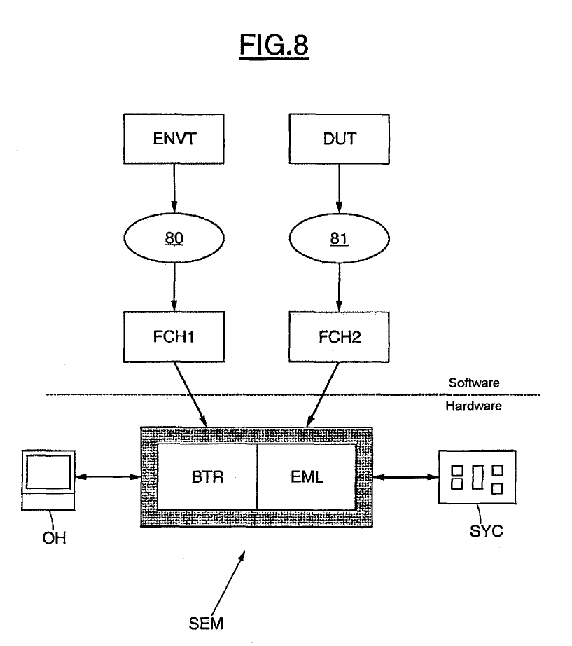

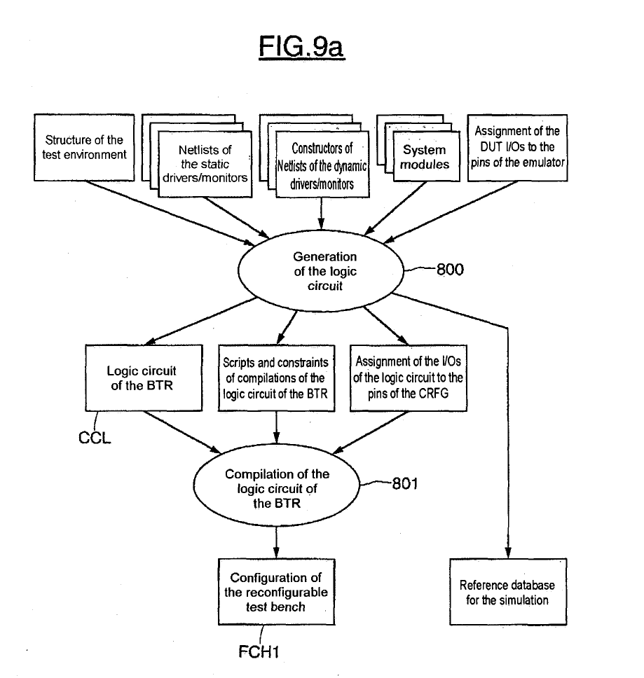

FIG. 8 diagrammatically represents a mode of implementation of a method of emulation according to the invention,

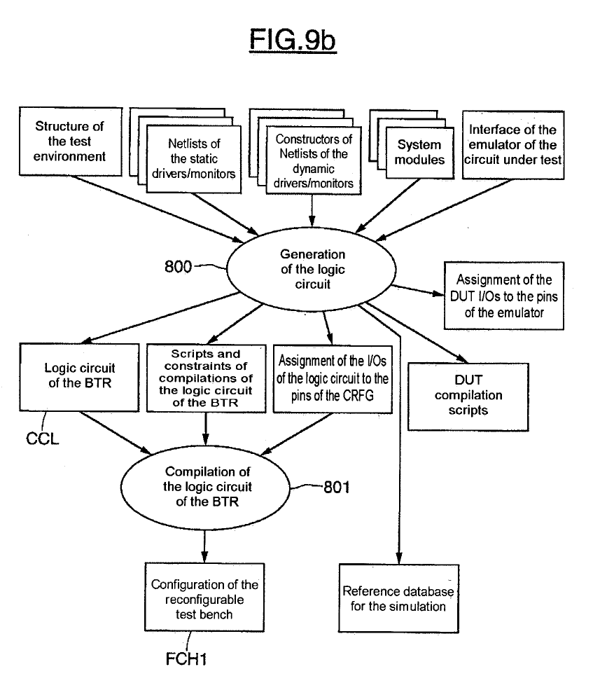

FIG. 9a illustrates in greater detail a general flow for generating the configuration of a reconfigurable test bench in the case where the design under test has already been compiled on its emulator,

FIG. 9b illustrates in greater detail a general flow for generating the configuration of a reconfigurable test bench in the case where the design under test has not yet been compiled on its emulator,

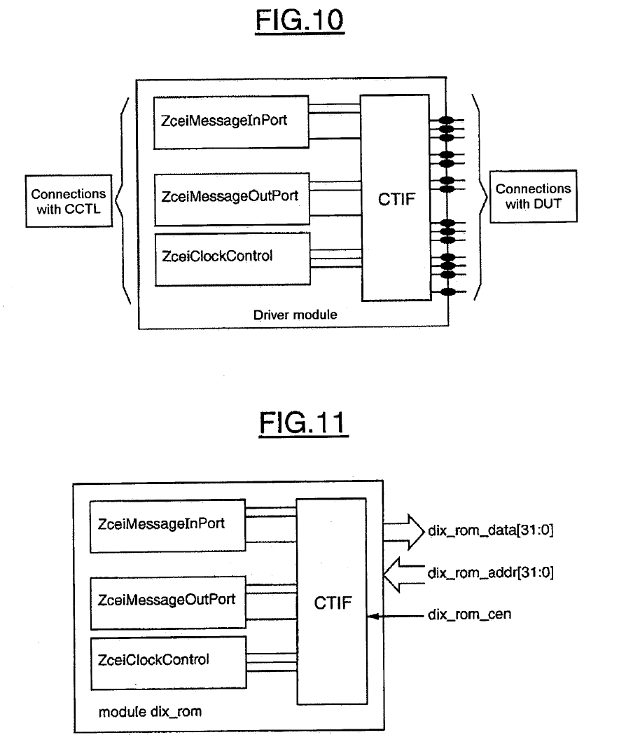

FIGS. 10 and 11 illustrate a representation of driver modules,

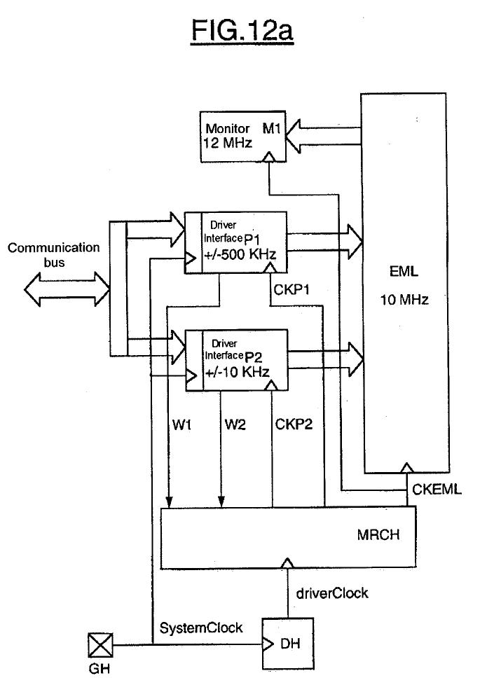

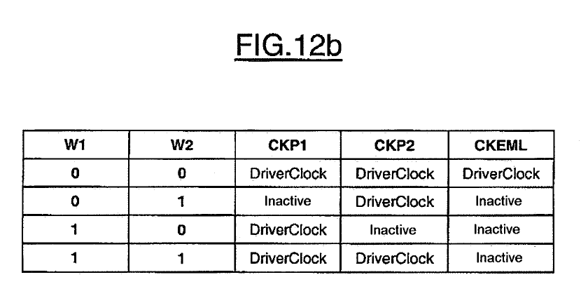

FIG. 12a diagrammatically illustrates an embodiment of means of clock retrocontrol according to the invention, and

FIG. 12b illustrates in the form of a table the behaviour of the retrocontrol circuitry implemented in respect of FIG. 12a.

A design under test can be modelled by a behavioural description at various levels of abstraction. The behaviour of the circuit can thus be described by a software model (for example a C or C++ program) and/or a hardware model expressed at the behavioural level, transfer of registers (RTL) or else as a network of gates. A hardware model can be simulated by specialised software called a hardware description simulator or else it can be emulated by a reconfigurable hardware system. In the second case, the emulated model corresponds directly to a hardware embodiment.

The invention relates to designs under test, at least part or the entire description of which is emulated by a reconfigurable hardware system.

In the subsequent text, interest will be focused solely on the case where the design under test is emulated completely by a reconfigurable hardware system, but it is obvious that this invention may easily be applied to the case where only a part of the design under test is emulated by a reconfigurable hardware system, it being possible for the other part to come in the form of a software model, executed (for example a processor simulator at instruction set level), or a simulated hardware model. The emulated part will then be regarded as becoming the design under test and the other part will be regarded as becoming its test environment.

As far as the test environment is concerned, the latter can be defined as representing all the means implemented by the designer of integrated circuits to validate his circuit. The inputs/outputs of the design under test are stimulated and observed by the test environment. The stimulation can be produced in a random manner or by taking account of the structural and functional characteristics of the design under test. The observation generally incorporates an analysis of the response of the design under test possibly with a comparison with the expected response. This expected response is determined as a function of the basic specifications of the circuit to be tested.

Like the design under test, the test environment can be defined through a complex software/hardware assembly. It can thus be defined by a combination of software and/or hardware models. These models will stimulate and observe the design under test and they will subsequently be referred to as drivers/monitors. The hardware models of the test environment may also be simulated or emulated. Having said this, a part of the test environment may also be embodied by genuine hardware.

A reconfigurable hardware system can correspond to a single reconfigurable circuit or to any arrangement of reconfigurable circuits. A reconfigurable circuit can be of FPGA type, such as those marketed by the companies XILINX or ALTERA, or a custom circuit having reconfigurability properties.

In FIG. 1, the reference SEM designates an emulation system according to the invention.

This system includes an emulator of the design under test EML and an assembly ENVT embodied as a test environment for this same design under test. A reconfigurable test bench BTR constitutes the central item of the test environment. It allows the emulator of the design under test to communicate with a host computer OH (whether it be a personal computer, a workstation or a server) and with a possible target device (or system) which must receive the design under test (in the case of an in-circuit emulation).

The reconfigurable test bench BTR communicates with the host computer OH across a fast bus such as a PCI, AGP bus or a fast interface such as Ethernet, SCSI.

In FIG. 2, the reconfigurable test bench BTR and the emulator EML are disposed on an internal electronic card CINT incorporated into the host computer and connected to the mother card CMR of this host computer. An internal card such as this can be a PCI card in the standard format, or an AGP card. The integration of the reconfigurable test bench and of the emulator of a host computer makes it possible to obtain better performance in respect of communication between the emulator and the central processing unit of the computer. This is all the more beneficial when the test environment is executed, interpreted or simulated on the host computer.

Having said this, several cards may also be used to install the reconfigurable test bench and the emulator so that the capacity of these two elements is increased. It then becomes necessary to define a means of communication between these two elements, enabling as far as possible the overall performance of the system not to be impaired.

As illustrated in FIG. 3, the reconfigurable test bench BTR comprises

a central part CR comprising, as will be seen in greater detail hereinbelow, at least one control circuit and at least one reconfigurable circuit,

a clock generator GH, and

static and/or dynamic memory circuits CMM.

The clock generator produces a base system clock useful for the operation of the reconfigurable test bench and possibly of the emulator when the clocks do not originate from the target system. The source of the generator can be a quartz or else the clock originating from the bus interface of the host computer.

The static and/or dynamic memories make it possible to store certain information useful during emulation.

There is also provided an external interface circuit IFSC, disposed on an external card CXT connected to the internal card CINT, this interface circuit embodying the interface between the central part CR of the reconfigurable test bench and the target system SYC.

The central part CR of the reconfigurable test bench comprises here, as illustrated in FIG. 4, a control circuit CCTL, a reconfigurable circuit for interfacing with the emulator CRFG and a bus interface circuit CIBS.

The bus interface circuit CIBS caters for the communication of the internal card CINT with the bus of the host computer. This interface can be embodied by using a special-purpose commercial circuit such as those marketed by the company PLX. The connecting of the reconfigurable circuit for interfacing with the emulator CRFG to the bus interface circuit CIBS makes it possible to obtain minimum latency in the communication between the processor of the host computer and the design under test. It is then possible to use a connection diagram with a three-point bus (as indicated in FIG. 4) or with a two-point bus and a bridge between the reconfigurable circuit for interfacing with the emulator CFRG and the control circuit CCTL. It should be noted that in the latter case, it may be advantageous to incorporate the function for interfacing with the bus of the host computer into the control circuit CCTL. If the latter is embodied by a reconfigurable circuit of Xilinx type, it will for example be possible to use a PCI interface macro proposed by this same manufacturer of reconfigurable circuits.

The control circuit carries out the fixed functions of the reconfigurable test bench. Its content is therefore defined independently of the design under test and of the test environment used. It may nevertheless comprise certain programmable parts.

The reconfigurable circuit for interfacing with the emulator CRFG serves to embody the interface of the reconfigurable test bench with the emulator of the design under test EML. The circuit CRFG also embodies the hardware parts of the test environment which will be defined by the user. The content of this circuit therefore depends on the test environment used and on its interface with the design under test.

The memory circuits CMM comprise static memory circuits CMMS, for example of the SRAM or SSRAM type, as well as dynamic memory circuits, for example of the SDRAM type. The dynamic memories may be implemented with separate memory components or by using memory modules. The memory components have the advantage of facilitating the phase of routing placement on the card whereas the modules add more flexibility as regards the subsequent evolution of the product.

The hardware architecture, as illustrated in FIG. 4, of the reconfigurable test bench has the advantage of proposing a decoupling between the actual core of the reconfigurable test bench carrying out the functions which are critical at the operating speed level and its interface with the emulator of the design under test requiring more reconfigurability. This gives better control of the parts which are critical at operating speed level and makes it possible to avoid having to compile the control circuit when the test environment changes. The solution which would consist in using just a single reconfigurable circuit to embody both the control circuit and the interface with the emulator of the design under test nevertheless has the advantages of simplified design and lower cost.

Although a single reconfigurable interface circuit CRFG has been represented here, it would also be possible to provide for several of them, for example two, linked to the same control circuit.

As indicated previously, the control circuit carries out the basic functions of the reconfigurable test bench. These functions are independent of the test environment of the circuit to be emulated. The control circuit is initialized on booting up the card, independently of the circuits under test which will subsequently be emulated.

The reconfigurable test bench comprises a main internal bus called the communication bus, which splits onto both the control circuit and the reconfigurable interface circuit or circuits CRFG. The communication bus is not completely controlled by the host computer, even if the latter is directly or indirectly at the origin of numerous transactions. Thus, at any moment, any hardware block connected to the bus can seek to communicate with another block without the initiator of this transaction necessarily being the host computer.

Accesses to the communication bus are managed by a global arbitration block ABG in the control circuit (FIG. 5) and by a local arbitration block in each interface circuit of the emulator. A block of the control circuit can therefore communicate with a block of the reconfigurable interface circuit in a transparent manner, that is to say as if the latter were part of the control circuit. Several arbitration mechanisms can be used to determine which hardware block will take over at a given moment. By way of example, an arbitration mechanism can consist in rotating the priorities with each cycle of the communication bus so that a request for access to the bus always ends up being served.

The control circuit also comprises the control part of a hardware logic analyser AL. This block consists of one more programmable automata whose state evolves as a function of the predefined or programmable triggers produced by the reconfigurable interface circuit of the emulator CRFG, as well as a collection of counters and of internal flags. This hardware block makes it possible to control a simulation sequence and to best utilize the trace memories which are embodied on the basis of the static or dynamic memories connected to the control circuit. The logic analyser thus formed borrows the general characteristics of a conventional logic analyser except that it benefits from the properties of the reconfigurations of the reconfigurable interface circuit in order to embody a hardware trace monitor and the triggers.

A clock controller CHL is synchronized by a base system clock (or primary clock) which can also advantageously serve to regulate the communication bus of the reconfigurable test bench. The clock controller produces groups of so-called secondary clock signals, corresponding to the clocks of the design under test and to the clocks of the various drivers/monitors and of the interfaces of drivers/monitors which are found in the reconfigurable circuit or circuits for interfacing with the emulator. The clock controller CHL can also receive as input clocks originating from the target system when the design under test is synchronized entirely or in part by external clocks.

The clock controller includes several independent generators supplying the secondary clock signals. The secondary clocks produced by a generator are interrelated according to specified frequency ratios and phase ratios. Each generator can communicate with various hardware blocks of the reconfigurable test bench so as to determine the advance of the secondary clocks which it has to supply to the design under test and to the drivers/monitors. Thus a software driver can for example slow down a clock produced by a generator so that this clock adapts to its stimulation rhythm, or a hardware trace driver can disable certain secondary clocks originating from certain generators for a certain amount of time so as to carry out a transfer of the data from the trace memory to the host computer. A block BC for combining the control signals centralizes the control signals originating from or going to the various hardware blocks involved in the control of the clocks.

A controller CSD of the dynamic memories SDRAM makes it possible to read or to write the dynamic memories connected to the control circuit CCTL from the host computer or the reconfigurable interface circuit CRFG. Similarly, a controller CSR of the static memories SRAM makes it possible to read or to write the static memories connected to the control circuit CCTL from the host computer or the reconfigurable interface circuit CRFG. During a simulation, these memories are used to sample the data originating from the interface bus with the emulator of the reconfigurable interface circuit CRFG. These memories may also be used for other uses such as storing various configurations of the emulator of the design under test, holding test vectors or else software applications executed by a hardware model of a complete system.

The control circuit CCTL also comprises a test interface IFG, complying with the JTAG standard, allowing fast access to the resources of the card from the host computer and doing so without going through an external cable. Such an interface can be used in a conventional manner to carry out production tests by verifying in particular the quality of the connections between the various components of the card. This interface also serves, on booting up the card, to identify the reconfigurable circuits used on the platform. The control block CCTL also comprises a configuration and readout interface IFCF, which makes it possible to configure or to read back the configuration of the various reconfigurable circuits of the emulation system.

An in-situ controller CIS allows the implementation of in-circuit emulation by initializing the external interface circuit IFSC and by controlling the communication between the emulated design under test and the target system.

Finally, the control circuit CCTL comprises interfaces I/F to various components external to the control circuit.

As FIG. 6 shows, as far as the test environment is concerned, the latter is modelled as a collection of drivers/monitors PLi and MNi interacting with the design under test DUT. The drivers PLi serve to stimulate the design under test whereas the monitors MNi serve to observe, that is to say to analyse the response of the design under test.

The drivers/monitors are defined by the user at different levels of abstraction (hardware description, programs, etc.) and correspond to software or hardware models.

In the world of emulation, the objective is to accelerate not only the design under test but also the greatest part of the test environment.

In the case of the emulation system according to the invention, there is then a distinction between the drivers/monitors stimulating the design under test from the software, which are called software drivers/monitors, and those which can be emulated or embodied by actual hardware, which are called hardware drivers/monitors. Figure 7a diagrammatically illustrates the general structure of the reconfigurable test bench BTR wherein the various drivers/monitors and interface of drivers/monitors of the test environment have been illustrated.

It is recalled here that the fixed part of the reconfigurable test bench carries out the functions of interfacing with the host computer and the target system and that it also carries out the functions of a logic analyser.

The variable part, that is to say the reconfigurable part, embodies the emulated hardware part of the test environment which can be viewed as a collection of hardware blocks interfacing with the design under test so as to stimulate it and observe it. These hardware blocks communicate moreover across various buses with the host computer OH, the target system SYC and the additional real hardware resources of the fixed part of the reconfigurable test bench BTR.

There are three types of hardware blocks:

Interface of software drivers/monitors: involving interfaces of software stimulation drivers/monitors establishing a communication with a software process executed on the host computer;

Emulated hardware drivers/monitors: involving hardware stimulation drivers/monitors which are emulated directly in the reconfigurable test bench.

Interfaces of real hardware drivers/monitors: involving interfaces of drivers/monitors of real hardware stimulation establishing a communication with hardware resources of the reconfigurable test bench, or with an external system, such as the target system.

In the last two cases, the associated hardware blocks mobilize only emulated or real hardware resources and they do not necessarily communicate with the host computer when they stimulate and observe the design under test.

FIG. 7b illustrates the content of the reconfigurable interface circuit CRFG. This reconfigurable interface circuit comprises predefined hardware blocks (or system modules) such as the interfaces of the buses connected to the control circuit CCTL or else the local arbitration block ABL and it also comprises variable hardware blocks which are generated as a function of the drivers/monitors used in the test environment.

The internal communication bus of the reconfigurable test bench is extended into the reconfigurable interface circuit CRFG. Certain hardware blocks of the reconfigurable interface circuit CRFG such as the interfaces of software drivers/monitors and the block for calculating the hardware triggers can thus transparently access the internal communication bus. A local arbitration block ABL determines the accesses to the communication bus as a function of the requests of the hardware blocks which are connected thereto.

A block for calculating the hardware triggers incorporates programmable triggers carrying out simple comparisons between one or more signals of the interface bus with the emulator and a given logic state, and also incorporates triggers generated on compilation as a function of the requirements in terms of logic analysis. It may for example involve a comparison between two vectorized signals of the bus for interfacing with the emulator. This block for calculating the hardware triggers may be regarded as the hardware block of a hardware monitor of the design under test, even if this monitor does not appear explicitly in the original test environment.

A block CSC for combining the control signals centralizes the control signals originating from or going to the various hardware blocks involved in the control of the clocks and communicates with the block BC of the control circuit CCTL.

The reconfigurable interface circuit CRFG next comprises the hardware blocks corresponding to the interfaces of drivers/monitors and the drivers/monitors required for the stimulation and the observation of the design under test. As in the case of the hardware block for calculating the triggers, these hardware blocks are connected entirely or partly to the bus for interfacing with the emulator. The bus for interfacing with the emulator can also serve to convey signals between the hardware blocks, thus allowing the debugging of the emulated hardware drivers/monitors or of the transactors (interfaces of software drivers/monitors of transactional level) by reusing the same means of debugging as those of the design under test.

FIG. 8 shows a general mode of implementation of the method of emulation according to the invention.

On the basis of a description of the test environment ENVT, a first configuration file FCH1 intended for configuring the reconfigurable test bench, and more precisely the reconfigurable circuit CRFG, is generated in a first generating phase 80.

On the basis of a description of the design under test DUT, a second configuration file FCH2 intended for configuring the emulator EML of the design under test, is generated in a second generating phase 81.

These two generating phases may be performed sequentially, in any order, or else in parallel.

FIG. 9a shows the general flow for generating the configuration of the reconfigurable test bench in the case where the design under test has already been compiled on its emulator. The generation of this configuration is split into two distinct steps:

the generation 800 of a logic circuit CCL consisting of a network of logic gates (or netlist) representative of the test environment, as well as of the compilation directives, and

a compilation 801 of this logic circuit CCL having regard to the said directives, so as to obtain the configuration file FCH1 which will make it possible to configure the reconfigurable test bench.

The step 800 for generating the logic circuit will also provide a reference database for the simulation, which will allow the software to know how to initialize the reconfigurable test bench and how to communicate with the reconfigurable test bench so as to stimulate/observe the design under test and ultimately recover certain results from the simulation.

The generator of the logic circuit also referred to as GenFW uses, when the design under test has already been compiled on its emulator, the following input parameters:

description of the assignment of the logical inputs/outputs of the design under test to the pins of the emulator,

description of the structure of the test environment: this involves the way in which the drivers/monitors are connected to the design under test (these also including the clocks), together with any parameters which define the conditions of use of these drivers/monitors, and furthermore the definition of the predefined triggers,

netlists of static drivers/monitors: this involves drivers/monitors whose hardware block to be included in the reconfigurable interface circuit CRFG is supplied directly in the form of a network of gates,

constructors of netlists of dynamic drivers/monitors: this involves drivers/monitors whose hardware block to be included in the reconfigurable interface circuit CRFG is produced in the form of a network of gates by a software module called dynamically by the generator GenFW,

system modules: these are the predefined hardware blocks necessary for incorporating the hardware blocks of the drivers/monitors into the reconfigurable test bench.

As far as the hardware blocks relating to the drivers/monitors are concerned, the generator GenFW therefore loads fixed netlists corresponding to drivers/monitors named “static” or netlists generated on the fly (or dynamically) by software modules and corresponding to drivers/monitors named “dynamic”.

The netlists of the static drivers/monitors and the software modules invoked by GenFW to produce the netlists of the dynamic drivers/monitors are supplied with GenFW, or are developed by the user or by a third party.

The generator GenFW also constructs the hardware block making it possible to combine certain control signals and the hardware block corresponding to the hardware triggers. Finally it assembles all the hardware blocks supplied or generated so as to produce the logic circuit in the form of a network of gates which will serve as a basis for the reconfiguration of the reconfigurable test bench and more especially of the reconfigurable interface circuit CRFG.

The generator GenFW supplies all the inputs required by the logic circuit compilation software to produce the binary configuration file FCH1 of the reconfigurable circuit CRFG. The files generated are as follows:

the netlist describing the logic circuit,

logic circuit compilation directives, that is to say:

scripts automating the compilation of the logic circuit and temporal and/or placement constraints for ensuring operation, of the logic circuit at a high frequency

an assignment of the inputs/outputs of the logic circuit to the pins of the reconfigurable interface circuit CRFG

a reference database required for the simulation allowing the software to communicate in a general manner with the reconfigurable test bench

The reference database for the simulation contains various files produced both by the software modules for drivers/monitors netlist generation and the generator GenFW.

It is also possible to compile the reconfigurable test bench before compiling the design under test.

In this case which is illustrated by FIG. 9b, the generation of the logic circuit is also responsible for performing the assignment of the inputs/outputs of the design under test to the pins of the emulator of the design under test. The generation of the logic circuit then uses as input parameter a description of the interface of the design under test, which may come for example in the form of a netlist representing the entire design under test or simply the interface of the higher-level model. The assignment of the inputs/outputs of the design under test to the pins of the emulators can be effected in a random manner or in a more deterministic fashion by applying heuristics making it possible to obtain more optimal assignments. Moreover, the generation of the logic circuit supplies as output compilation directives in respect of the design under test through the compilation scripts and a description of the assignment of the logic inputs/outputs of the design under test to the pins of the emulator, this output description being moreover a constraint parameter in respect of the compilation of the design under test on the emulator.

The functionality of the means of generation genFW of the logic circuit will now be described in greater detail in the case where the reconfigurable interface circuit CRFG and the emulator of the design under test are based on a reconfigurable circuit of the FPGA type from the company XILINX. In this case, the compilation step is performed with the aid of compilation software, also called the placement & routing tool, such as the ISE 4.2 software marketed by the company XILINX. In the subsequent text and for simplification purposes, the generating means GenFW will be designated by their reference GenFW, and the design under test will be designated by its reference DUT.

Referring again to FIG. 9a, the compilation of the DUT by the XILINX compilation software supplies a file with extension “.pad”, for assigning the inputs/outputs of the DUT to the pins of the reconfigurable emulation circuit. This file contains the list of its inputs/outputs, together with their direction and the physical pin of the reconfigurable circuit (FPGA) to which they are assigned. By taking this information into account, GenFW is able to correctly place the inputs/outputs of the reconfigurable test bench by generating an assignment of the inputs/outputs of the logic circuit for the reconfigurable interface circuit CRFG. This assignment is produced in the form of a file with extension “.ucf”, describing the constraints in respect of the Xilinx compilation software.

The structure of the test environment is described by a file with extension “.dve”, giving the list of drivers/monitors instantiated in the test environment and the definition of the hardware triggers. For each driver/monitor, this file describes the connection to the DUT and possibly to other drivers/monitors (this also including the block for calculating the hardware triggers) according to a syntax much like the Verilog language. It also contains the various parameters (“defparam” directives) which make it possible to configure each driver/monitor and to define those clocks with which a driver/monitor synchronizes itself. An example is given below:

// Instantiation of an emulated hardware driver generating
// random numbers
randomModel randgen (

.clk(clkO),
.val( din[15:0] ) );

zceiClockPort dut_clock0 ( .cclock(clk0) );
assign trigger0= din[0] | | din[1];

A circuit is stimulated by an emulated hardware driver whose model name is ‘randomModel’. The “.dve” file indicates the name under which the model of the driver is to be instantiated in the logic circuit (‘randgen’) and how the driver is connected to the design under test. Thus the connector ‘clk’ of the driver is connected to the clock ‘clk0’ of the design under test, and the connector ‘val’ is connected to the vectorized input ‘din’ of this same design under test. The trigger ‘trigger0’ is defined as being an OR function on the signals ‘din[0]’ and ‘din[1]’, so that ‘trigger0’ is active when one of the two signals ‘din[0]’ or ‘din[1]’ is active.

It should be noted that the structure of the test environment could just as well be described by a hardware description in a language such as VHDL or Verilog. Moreover in certain cases (monolithic test environment, that is to say one consisting of a single driver/monitor stimulating/observing all the inputs/outputs of the design under test), the “.dve” file may itself be generated automatically by the program GenFW by relying on the description of the interface of the design under test.

GenFW supports the instantiation of hardware or software drivers/monitors directly supplied with the emulation system according to the invention, but also of drivers/monitors developed by the user or by third parties. A typical case of a driver/monitor developed by the user corresponds to the emulated hardware driver/monitor. The user simply supplies an EDIF netlist of his driver/monitor, which will be instantiated by GenFW in the reconfigurable interface circuit CRFG. A typical case of a driver/monitor developed by third parties relates to transactors. In this case, the transactional software driver/monitor interface can come either directly in the form of an EDIF netlist, or may be generated by a software module according to certain parameters defined in the “.dve” file. GenFW must therefore be able to invoke such a software module with its correct parameters and be able to recover the resulting netlist EDIF so as to insert it into the reconfigurable interface circuit CRFG.

GenFW makes it possible to implement a generic approach in which each driver/monitor hardware block is processed in an impartial manner, independently of its characteristics, of who designs it and of the manner in which it is produced. Certain drivers/monitors are supplied with the emulation system according to the invention, but others may be developed by the user or a third party.

Each driver/monitor is linked to a directory which contains the information required for the possible generation and for the use of the hardware block to be inserted into the reconfigurable interface circuit CRFG. This directory contains in particular a file with extension “.install” which indicates the type of the driver/monitor (static/dynamic) and the method of producing the netlist in the case of a dynamic driver/monitor.

In the case of a static driver/monitor, the file with extension “.install” simply specifies the name of the EDIF netlist to be loaded by GenFW.

An example of an “.install” file is given below for a static driver/monitor named DLX_ROM:

// Definition of a driver/monitor interface simulating the ROM-
program of the DLX processor
// file : DLX_ROM.install
DLX ROM {

NETLIST = “dlx_rom.edif” ;
}

In this example, the “.install” file indicates the name of the EDIF netlist file to be loaded into genFW, in this instance ‘dlx_rom.edif’.

A dynamic driver/monitor is constructed by a software module capable of generating the EDIF netlist to be inserted into the reconfigurable interface circuit CRFG. The software module corresponds to a script file, an executable program, one or more files describing a hardware model to be synthesised, or finally a library which can be loaded dynamically into GenFW. The software module must comprise an entry point so that GenFW can invoke the generation of the netlist of the hardware block of the driver/monitor with certain generating parameters. In the case of a dynamic library, this generating function is called by GenFW, supplying it as parameters with all the information relating to an instantiation of the driver/monitor, such as described in the “.dve” file. An example of an “.install” file for a dynamic driver/monitor, is given below:

// Definition of the cosimulation driver C
// file : C_COSIM.install
C_COSIM {

| | |
|---|---|
| LIB_NAME = “genCCosim.so” ; | // dynamic library |
| FCT NAME = “genCCosimNetlist” ; | // main function |
| } | |

The software module is described as being a dynamic library (‘genCCosim.so’) to which GenFW will dynamically link. The entry point of the software module is the function ‘genCCosimNetlist’ which is called by GenFW with a particular prototype.

This prototype comprises as parameter the data structure representing the instantiation of the driver/monitor in the “.dve” (name of instance, connections to the DUT, directives ‘defparam’ etc.).

The function supplies a netlist to GenFW which is responsible for instantiating it in the netlist of the reconfigurable interface circuit CRFG.

It should be noted that the software module (through the function ‘genCCosimNetlist’) can also supply information which will supplement the reference database for the simulation.

Thus, the C cosimulation driver/monitor generator (genCCosim.so) produces a C (or C++) file which contains the data structures and the functions required by the user to stimulate, from a C (or C++) application, the signals of the DUT which it has linked to the cosimulation driver/monitor (connections made explicit in the file with extension “.dve”).

GenFW ultimately produces a netlist in the EDIF format for the logic circuit, which serves as basis for the configuration of the reconfigurable interface circuit CRFG.

This netlist includes the description and carries out the interconnection of the various hardware blocks of the drivers/monitors and of the system modules.

GenFW also produces a file with extension “.ucf” to express the constraints of placement of the inputs/outputs of the logic circuit on the reconfigurable interface circuit CRFG. This file, intended for the Xilinx compilation software, also contains temporal constraints (in particular in respect of the blocks for interfacing the reconfigurable circuit CRFG with the control circuit CCTL).

At the level of the reference database for the simulation, GenFW also generates the file containing the list of hardware blocks which are introduced into the netlist of the logic circuit embodied by the reconfigurable interface circuit CRFG and requiring an interaction (initialization or communication) with the software.

This file contains in particular:

the list of clocks used by the design under test and the drivers/monitors of the test environment

the list of drivers/monitors having access to the communication bus of the reconfigurable test bench. Access to the bus is implemented by one or more communication ports (in send or receive mode) present in the netlist of the hardware block of each driver/monitor.

FIG. 10 diagrammatically illustrates the architecture of a hardware block corresponding to a software driver/monitor interface.

The architecture of the interfaces of software drivers/monitors and the connection semantics borrow certain principles from the SCE-MI standard, but the latter has been adapted so as also to be able to establish a communication with the software at the bit/signal level.

The hardware block of a software driver/monitor interface contains a CTIF module which communicates on the one hand with the DUT (according to the connections which have been described explicitly in the “.dve” file) and on the other hand with the communication bus of the reconfigurable test bench through the particular cells called communication “ports”.

These communication ports which are instantiated in the netlist of the hardware block of the interface of the software driver/monitor, can be of three different types:

ZceiMessageInPort: allows the disptaching of messages from the software to the CTIF module,

ZceiMessageOutPort: allows the disptaching of messages from the CTIF module to the software,

ZceiClockControl: allows control of the advance of the clock applied to the DUT (also called the “retrocontrol” mechanism) and which is also associated with the driver/monitor.

The role of GenFW is therefore, once the netlist of the hardware block of the interface of the software driver/monitor has been read or constructed:

to link the connectors of the netlist to the internal signals of the logic circuit, and in particular to the bus for interfacing with the emulator so that the netlist is ultimately linked to the connectors of the design under test in accordance with the indications of the file with extension “.dve”

to replace the black boxes ZceiMessageInPort and ZceiMessageOutPort by modules connected to the communication bus of the reconfigurable circuit CRFG, itself being a local extension of the communication bus of the control circuit CCTL, and therefore allowing the exchange of data with the software

to replace the black boxes ZceiClockControl by logic connected to external ports of the reconfigurable circuit CRFG;

FIG. 11 illustrates an example of a hardware block for a static software driver/monitor interface ‘dlx_rom’.

The software driver/monitor ‘dlx_rom’ serves to stimulate the DUT (in this instance a DLX processor) by simulating through software the operation of a read only memory (ROM) containing the program of the DLX.

The connectors of the hardware block ‘dlx_rom’ are:

dlx_rom_data: vector of 32 outputs which supplies the DLX with the data read from the memory.

dlx_rom_addr: vector of 32 inputs which generates the memory address which the DLX wishes to read.

dlx_rom_cen: an input whose function is the selection of the memory by the DLX.

The implementation of the driver/monitor dlx_rom requests its instantiation in the “.dve” file, according to the following form:

// instance ‘rom_program’ of a driver/monitor ‘dlx_rom’
dlx_rom rom_program (

.dlx_rom_data( rom_data[31:0] ),
.dlx_rom_addr( rom_addr[31:0] ),
.dlx_rom_cen ( rom_cen )
);

// The clock of the DUT CLK is produced by the generator ‘clkprt’
zceiClockPort clkprt ( .cclock(clk) );
// ‘DLX_CLK’ is an alias of the clock of the DUT (produced by the
// generator ‘clkprt’)
defparam clkprt.cclock = DLX_CLK
// the instance ‘rom_program’ of the driver/monitor retro-controls
the clock
// DLX_CLK, and hence the clock of the DUT
defparam rom_program.cclock = DLX_CLK;

These lines of the “.dve” file signify (for GenFW):

that it is necessary to create an instance named ‘rom_program’ of the model ‘dlx_rom’ in the logic circuit.

that the vector of connectors ‘dlx_rom_data’ of the instance ‘rom_program’ must be connected to the input signals ‘rom_data[31]’ to ‘rom_data[0]’ of the DUT, which are accessible by the bus for interfacing with the emulator.

that the vector of connectors ‘dlx_rom_addr’ of the instance ‘rom_program’ must be connected to the output signals ‘rom_addr[31]’ to ‘rom_addr[0]’ of the DUT which are accessible by the bus for interfacing with the emulator.

that the connector ‘dlx_rom_cen’ of the instance ‘rom_program’ must be connected to the output signal ‘rom_cen’ of the DUT which is accessible by the bus for interfacing with the emulator.

The first line ‘defparam’ of the “.dve” file means that the clock generated by the generator ‘ZceiClockPort’ is also called ‘DLX_CLK’. The second line ‘defparam’ means that this clock ‘DLX_CLK’ is retro-controlled by the software driver/monitor ‘dlx_rom’ thereby indicating that the design under test will operate at a frequency determined according to the speed of stimulation of the driver/monitor.

The following example illustrates the case of a dynamic software driver/monitor whose ports are of a variable size.

// instance ‘ccode’ of a software driver/monitor C_COSIM
C_COSIM ccode (

.input_bin( { data[63:0], ack, ctrl[3:0] } ),
.output_bin( { addr[31:0], wen } )
);

defparam ccode.cclock = CLK;
// The clock of the DUT CLK is produced by the generator ‘clkprt’
zceiClockPort clkprt ( .cclock(clk) );
// CLK is the name of the clock generated for the DUT
defparam clkprt.cclock = CLK
// the driver/monitor ‘ccode’ retro-controls the clock ‘CLK’
defparam ccode.cclock = CLK;

In this file with extension “.dve”, the connectors ‘input_bin’ and ‘output_bin’ of the driver/monitor C_COSIM are not of predefined dimension. genFW adapts their size as a function of the number of signals which it has to connect.

Another exemplary use of GenFW will now be described.

In this example the circuit DUT to be emulated with the emulation system according to the invention is a 4-bit counter described in the verilog language.

// description of the 4 bit counter in VERILOG language
module counter_4bits ( rst, clk, data );

| input rst, clk; | |
|---|---|
| output [3:0] data; | |
| reg | [3:0] data; |

always @(posedge clk or posedge rst) begin

| | |
|---|---|
| if (rst) data <= 0; | // reset the counter to zero |

else data <= data + 1; // advance on ‘clk’ clock edge

end

enmodule

The user must then use a logic synthesis tool (for example that known by the name leonardo from the MENTOR GRAPHICS company) to transform the VERILOG description of the counter into an EDIF netlist. The EDIF netlist obtained will be called ‘counter_{—}4bits.edf’ in the remainder of the example.

The EDIF netlist ‘counter_{—}4bits.edf’ serves as entry point describing the DUT to the XILINX compilation chain.

In this example, the test environment comprises only a software driver/monitor corresponding to a C/C++ program done by the user.

// instance of a driver C_COSIM
C_COSIM stimul (

.input_bin ( rst ),
.output_bin ( data[3:0] )
);

defparam stimul.cclock = CLK_ID;
zceiClockPort clock ( .cclock(clk) ); // clk is a clock of the DUT
defparam clock. cclock = CLK_ID;

This file, named for example ‘counter_{—}4bits.dve’, means that the user of the emulation system according to the invention wishes to control the value of the DUT reset signal ‘rst’, as well as the advance of the clock ‘clk’ in its C/C++ program.

He also wishes to read the value of the signal ‘data[3:0]’ produced by the DUT in its program.

In what follows, the use of GenFW without prior compilation of the DUT with the XILINX compilation software is presented.

The user can call GenFW with the command:

genFW -edf counter_{—}4bits.edf -dve counter_{—}4bits.dve

The genFW input files are:

‘counter_{—}4bits.edf’: the EDIF netlist of the DUT,

‘counter_{—}4bits.dve’: the structure of the test environment.

The output files are:

‘fp_firmware.edf’: the netlist of the logic circuit CCL (content of the reconfigurable circuit CRFG),

‘fp_firmware.ucf’: the constraints of placement of the inputs/outputs of the reconfigurable circuit CRFG,

‘fp_firmware.xref’: data for the simulation software,

‘counter_{—}4bits.ucf’: the constraints of placement of the inputs/outputs of the reconfigurable circuit forming the emulator EML,

‘stimul.c’: C file for the implementation of the cosimulation driver/monitor in the C/C++ program of the user.

The file ‘counter_{—}4bits.ucf’ produced by GenFW contains the constraints of placement of the inputs/outputs of the DUT on the pins of the reconfigurable circuit forming the emulator EML, which is for example an FPGA circuit designated in what follows by the term FPGA DUT.

Likewise in what follows the reconfigurable circuit CRFG is designated by the term FPGA FP.

The UCF format used is an XILINX proprietary format.

# XILINX constraints to the UCF format for counter_4bits
# the FPGA-DUT is a circuit XCVE1600 FG1156
NET “data(3)” LOC = “AP15”;
NET “data(2)” LOC = “AL16”;
NET “data(1)” LOC = “AE14”;
NET “data(0)” LOC = “AN16”;
NET “rst” LOC = “AF16”;
NET “clk” LOC = “AH18”;

In this file, AP15, AL16, . . . , AH18 are names of pins of the FPGA DUT, in accordance with the XILINX nomenclature.

GenFW chooses pins of the FPGA DUT which are connected to the reconfigurable test bench BTR (so that the test bench BTR can control the inputs/outputs of the DUT). Moreover, the pin AH18 used for the ‘clk’ input is a clock pin of the FPGA DUT: GenFW has decided to place ‘clk’ on one of the networks of clocks of the FPGA DUT based on the instantiation of the ‘zceiClockPort’ in the file ‘counter_{—}4bits.dve’.

In this example, the FPGA DUT is a VIRTEX-E 1600 circuit with a 1156-pin package; the names of the pins chosen by GenFW are compatible with this type of FPGA. The use of another model of FPGA would likely lead to a different choice of pins.

The file ‘fp_firmware.edf’ is the EDIF netlist of the FPGA FP of the reconfigurable test bench. It contains the instance ‘stimul’ of the cosimulation driver/monitor C ‘C_COSIM’ in accordance with what was described previously.

The file ‘fp_firmware.ucf’ contains the constraints of compilation of the netlist of the reconfigurable circuit CRFG by the XILINX compilation software. As indicated by the extract below, the constraints describe the placement of the input/output signals of the logic circuit CCL on the pins of the FPGA FP, but also temporal constraints such as the minimum frequency required for the system clock of the reconfigurable test bench.

# XILINX constraints to the UCF format for FP
# the FPGA-FP is of the model XCVE1600 FG900
...
NET “data(3)” LOC = “F1”;
NET “data(2)” LOC = “G3”;
NET “data(1)” LOC = “L10”;
NET “data(0)” LOC = “E4”;
NET “rst” LOC = “H7”;
...
# other constraints not presented in this extract
...
# frequency constraint: 50 MHz system clock
TIMESPEC “TS_clk” = PERIOD “sys_clk” 20 ns HIGH 50%
...

In the extract presented above, GenFW has chosen the pins F1, G3, L10, E4 and H7 for the placement of the input/output signals ‘data(3)’ . . . ‘rst’ which are to be linked to the similarly named signals of the DUT since:

the pin ‘F1’ of the FPGA FP is linked to the pin ‘AP15’ of the FPGA DUT

the pin ‘G3’ of the FPGA FP is linked to the pin ‘AL16’ of the FPGA DUT

the pin ‘L10’ of the FPGA FP is linked to the pin ‘AE14’ of the FPGA DUT

the pin ‘E4’ of the FPGA FP is linked to the pin ‘AN16’ of the FPGA DUT

the pin ‘H7’ of the FPGA FP is linked to the pin ‘AF16’ of the FPGA DUT.

In this example, the FPGA FP is a VIRTEX-E 1600 circuit with a 900-pin package; the names of the pins chosen by GenFW are compatible with this type of FPGA. The use of another model of FPGA would likely lead to a different choice of pins.

The file ‘fp_firmware.xref’ is intended for the interface with the software. It indicates the resources inserted into the reconfigurable test bench allowing the control of the emulation system by the program executed on the host computer.

$NbPorts = 2 ;
$PortSpec_1 = << stimul txp 1 >> ;
$PortSpec_0 = << stimul rxp 0 >> ;
$Clock_0 = “CLK_ID” ;

This file indicates that the reconfigurable test bench generated by GenFW contains two communication ports linking the interface of the software driver/monitor ‘stimul’ to the communication bus of the reconfigurable test bench

port 0 (declaration $PortSpec_{—}0): port ‘rxp’ of the driver/monitor ‘stimul’ instantiated in the file “.dve”

port 1 (declaration $PortSpec_{—}1): port ‘txp’ of the driver/monitor “stimul” instantiated in the file “.dve”

It also indicates that clock generator number 0 is used to produce the DUT clock referenced under the name ‘CLK_ID’.

Reference is now made to FIG. 12a to describe a clock retrocontrol means MRCH. Specifically, whereas the design under test and certain drivers/monitors (generally of hardware type) can operate at high frequencies (10 MHz for example), other drivers/monitors (generally of software type) can not only not operate at such frequencies in continuous mode, but moreover cannot stimulate/observe the design under test at a constant and predetermined frequency. In FIG. 12a, two interfaces of software drivers P1 and P2 operating on average at 10 kHz and at 500 kHz respectively have been represented, as has an emulated hardware monitor M1 which can reach a maximum frequency of operation of 12 MHz.

It is therefore appropriate to provide a “variable frequency” clock, that is to say one which can adapt best to the possibilities of the drivers/monitors involved in the test environment.

The example of FIG. 12a concentrates on the retro-control means implemented in order to produce the secondary clocks synchronizing the emulator of the design under test and certain drivers/monitors of the test environment. Within the framework of the reconfigurable test bench, these retro-control means are implemented by one of the generators of the clock controller CHL of the control circuit CCTL.

More precisely, the means MRCH, composed of logic gates receive the clock signal driverClock delivered by the clock divider DH regulated by the base clock signal systemclock. The division factor is determined in such a way that the frequency of the clock driverClock cannot exceed the maximum frequency of operation of the emulated design under test and of the hardware drivers/monitors.

The means MRCH also receive two wait signals w1 and w2 sent by the two drivers P1 and P2, and deliver the clock signals ckp1, ckp2 to their two respective software drivers, and the clock signal ckEML to the hardware monitor M1 and to the emulator of the design under test EML.

FIG. 12b shows a table describing the behaviour of the outputs of the block MRCH as a function of its inputs.

When the wait signal w1 is at 1 (active), the signals ckp2 and ckEML are halted, but the clock ckp1 still remains active (this may be the direct or divided clock driverClock).

When the wait signal w2 is at 1 (active), the signals ckp1 and ckEML are halted, but the clock ckp2 still remains active (this may be the direct or divided clock driverClock).

When both signals w1 are w2 are simultaneously at 0 (inactive), all the clocks are active.

When both signals w1 and w2 are simultaneously at 1 (active), only the clock ckEML is halted.

It should be noted that the number of clock signals used in the test environment can be reduced by using signals for activation on the clock driverClock, given that when the secondary clocks are active, they all derive from the clock driverClock.

Thus more generally the clock signals generator MRCH, synchronized by the divided base system clock, delivers various secondary clock signals synchronizing the emulator of the design under test and certain at least of the hardware means of the test bench. The clock retrocontrol means are then capable in response to at least one wait signal sent by one of the hardware means of the test bench regulated by a first secondary clock signal, of temporarily disabling certain of the other secondary clock signals with different frequencies from that of the first secondary clock signal.

1. Method of emulating a design under test associated with a test environment, characterized in that it comprises two distinct generating phases comprising a first phase of generating (80) a first file (FCH1) for configuring the test environment, and a second phase of generating (81) a second file (FCH2) for configuring at least a part of the design under test, the delivery of the first configuration file to a first reconfigurable hardware part (BTR) forming a reconfigurable test bench so as to configure the test bench, and the delivery of the second configuration file to a second reconfigurable hardware part (EML) so as to configure an emulator of the design under test, the two hardware parts being distinct and mutually connected.

2. Method according to claim 1, characterized in that the first generating phase (80) comprises the production (800) of a logic circuit (CRL) consisting of a network of logic gates and representative of the test environment as well as of the compilation directives, and a compilation (801) of this logic circuit having regard to the said directives, so as to obtain the first configuration file (FCH1).

3. Method according to claim 2, characterized in that the test environment comprises a collection of drivers (PLi) and of monitors (MNi), and in that the production of the said logic circuit comprises the formation of hardware blocks in the form of networks of logic gates, these hardware blocks representing interfaces of drivers/monitors of software stimulation, interfaces of drivers/monitors of real hardware stimulation, and drivers/monitors of emulated hardware stimulation, blocks for calculations of hardware triggers, as well as a block for interfacing with the emulator of the design under test.

4. Method according to claim 3, characterized in that the phase of forming the hardware blocks is effected on the basis of statically defined networks of gates or of networks of gates which are generated dynamically by a software module.

5. Method according to one of the preceding claims, characterized in that the first generating phase (80) and the second generating phase (81) are performed in parallel.

6. Method according to one of claims 1 to 4, characterized in that the first generating phase (80) and the second generating phase (81) are performed sequentially.

7. Method according to claim 6, characterized in that the first generating phase (80) is performed before or after the second generating phase (81).

8. Method according to claims 3 and 7, characterized in that when the first generating phase is performed after the second generating phase, the production of the logic circuit (CRL) uses as input parameters a description of the assignment of the logic inputs/outputs of the design under test to the pins of the emulator, and in that when the second generating phase is performed after the first generating phase, the production of the logic circuit uses as input parameters a description of the interface of the design under test and supplies as output a description of the assignment of the logic inputs/outputs of the design under test to the pins of the emulator, this output description then being a constraint parameter for the second generating phase.

9. Emulation system, intended to emulate a design under test associated with a test environment, characterized in that it comprises a reconfigurable hardware test bench (BTR) capable of emulating a part at least of the test environment, this test bench being connected between a host computer and a reconfigurable hardware emulator (EML), distinct from the test bench, and capable of emulating at least a part of the design under test, first generating means able to generate a first file for configuring the test environment, and second generating means able to generate a second file for configuring the design under test.

10. System according to claim 9, characterized in that the reconfigurable test bench (BTR) comprises a so-called fixed part and at least one reconfigurable interface circuit (CRFG) capable of embodying the emulated part of the test environment.

11. System according to claim 10, characterized in that the fixed part comprises at least one control circuit (CCTL) and one circuit (CIBS) for interfacing with the host computer, and in that the reconfigurable interface circuit is able to comprise at least interfaces of drivers/monitors of software stimulation which are capable of establishing a communication with at least one software process executed on the host computer, and drivers/monitors of emulated hardware stimulation.

12. System according to claim 11, characterized in that the fixed part furthermore comprises additional real hardware drivers/monitors, and in that the reconfigurable circuit (CRFG) is able furthermore to comprise interfaces with these additional real hardware drivers/monitors.

13. System according to one of claims 9 to 12, characterized in that the fixed part furthermore comprises a circuit (IFSC) for interfacing with a target device (SYC).

14. System according to one of claims 9 to 13, characterized in that the fixed part furthermore comprises the control part of a hardware logic analyser (AL) whose state evolves as a function of the hardware triggers.

15. System according to one of claims 9 to 14, characterized in that the reconfigurable test bench comprises a clock signals generator synchronized by a base system clock and delivering various secondary clock signals synchronizing the emulator of the design under test and certain at least of the hardware means of the test bench, as well as clock retrocontrol means capable in response to at least one wait signal transmitted by one of the hardware means of the test bench regulated by a first secondary clock signal of temporarily disabling certain of the other secondary clock signals with different frequencies from that of the first secondary clock signal.

16. System according to one of claims 9 to 15, characterized in that the test bench and the emulator are embodied on an electronic card external to the host computer and connected to the latter's mother card.

17. System according to one of claims 9 to 15, characterized in that the reconfigurable test bench is embodied on a first electronic card external to the host computer and connected to the latter's mother card, and in that the emulator of the design under test is embodied on one or more other cards external to the host computer and connected to the said first external card.

18. System according to claim 17, characterized in that the circuit for interfacing with the target device is integrated into the said first external card.

19. System according to one of claims 10 to 16, characterized in that the test bench and the emulator are embodied on an internal electronic card (CINT) incorporated into the host computer.

20. System according to claims 13 and 19, characterized in that the circuit for interfacing with the target device is embodied on an external electronic card (CXT) outside the host computer, and able to be connected to the said internal electronic card (CINT).

21. Electronic card, intended to be connected to the mother card of a host computer, characterized in that it comprises a reconfigurable hardware test bench (BTR) capable of emulating a part at least of a test environment associated with a design under test, and a reconfigurable hardware emulator (EML), distinct from the test bench, connected to the reconfigurable test bench and capable of emulating at least a part of the design under test.

22. Card according to claim 21, characterized in that the reconfigurable test bench (BTR) comprises a so-called fixed part and at least one reconfigurable circuit capable of embodying the emulated part of the test environment.

23. Card according to claim 22, characterized in that the fixed part comprises at least one control circuit (CCTL) and one circuit for interfacing with the host computer, and in that the reconfigurable circuit is able to comprise at least interfaces of drivers/monitors of software stimulation which are capable of establishing a communication with at least one software process executed on the host computer, and drivers/monitors of emulated hardware stimulation.

24. Card according to claim 23, characterized in that the fixed part furthermore comprises additional real hardware drivers/monitors, and in that the reconfigurable circuit is able to comprise further interfaces with these additional real hardware drivers/monitors.

25. Card according to one of claims 21 to 24, characterized in that the reconfigurable test bench comprises a clock signals generator synchronized by a base system clock and delivering various secondary clock signals of different frequencies, as well as clock retrocontrol means capable in response to a wait signal transmitted by one of the hardware means of the test bench regulated by a first secondary clock signal of temporarily disabling the secondary clock signals with different frequencies from that of the first secondary clock signal.
